(19) United States
(12) Patent Application Publication
(10) Pub. No.: US 2023/0108060 A1
(43) Pub. Date: Apr. 6, 2023

(54) SYSTEM AND METHOD FOR PROVIDING UNINTERRUPTIBLE POWER SUPPLY USING ONE OR MORE ENERGY SOURCES

(71) Applicants: SUDARSHAN S KRISHNAMOORTHY, Bangalore (IN); SNEHAL R MESHRAM, Bangalore (IN)

(72) Inventors: SUDARSHAN S KRISHNAMOORTHY, Bangalore (IN); SNEHAL R MESHRAM, Bangalore (IN)

(21) Appl. No.: 17/960,845

(22) Filed: Oct. 6, 2022

(30) Foreign Application Priority Data
Oct. 6, 2021 (IN) 202141045530

(51) Int. Cl. H02J 9/06

(52) U.S. Cl. CPC H02J 9/062; H02J 9/068

(57) ABSTRACT

A method and system of providing a power supply to a load (108) using a micro-grid (122) and an electrical grid (102) without interrupting a power supply to the load (108) during a power failure and restoration of the electrical grid (102). A non-grid AC sine wave is synchronized to a grid AC sine wave at the AC to AC synchronization circuit (120) when the electrical grid (102) power supply is restored, without turning OFF the DC to the AC inverter (118) by performing synchronization of the non-grid AC sinewave to match the grid AC sine wave over a number of cycles to make the non-grid AC sine wave compatible with the grid power supply while the power supply generated from the non-grid sources (116) remains uninterrupted and the voltage is in the predetermined threshold range for providing to the load (108).

### BACKGROUND

### Technical Field

The embodiments herein generally relate to a inverter system for providing a power supply to a load, and more particularly, a system and method for providing uninterruptible power supply using one or more energy sources with a protective islanding that is created during a power failure using a microcontroller driven smart relay.

### Description of the Related Art

In present scenario, renewable or non-grid energy (e.g. solar, wind, etc.) is progressively more valued and employed worldwide because of energy shortage, cleanliness and sustainability than electrical grid energy. However, as non-grid sources are not available all the time, there is a need to draw power from grid sources. Currently, the non-grid sources are utilized using a grid-tie mechanism (i.e. hybrid model), where the non-grid energy is added with the electrical grid energy to provide power supply in an uninterrupted manner.

Some hybrid models are currently existing for an uninterrupted power supply (UPS), namely, hybrid off-line, hybrid on-line and grid-tied systems. The existing hybrid models provide means to add the non-grid sources to grid energy mix. However, the existing hybrid models may not utilize the non-grid sources fully or may lose out on a system efficiency. For example, if power is needed in excess of what can be supplied by the non-grid sources in the hybrid off-line model, a model switches to the grid energy with the help of relays. Hence, the non-grid sources are left completely unused. In case of the hybrid on-line model, there is a need of dual conversion to provide the power supply, which reduces an overall system efficiency to 75%.

The grid-tied systems use special circuits called Phase Locked Loops (PLL) to match a frequency and a phase of the grid energy to the non-grid sources are being tied to. However, the existing grid-tied systems lack protective islanding feature as the grid-tied systems are directly connected to the electrical grid. Due to this direct connection, the grid-tied systems need various country electrical code to utilize the power from the non-grid sources during grid power failure to prevent accidental electrocution of personnel working in repair of the electrical grid infrastructure. With the lacking of the protective islanding feature, the grid-tied systems cannot supply power from the non-grid sources during the grid power failure even when there is abundant supply of the non-grid sources.

In some existing UPS systems, the grid is connected with the non-grid sources using a relay switch which switches the UPS system to supply the power from the grid source, the non-grid sources or both based on grid power detection in order to provide the uninterrupted power supply. However, the power supply is still interrupted due to a momentary glitch caused by the relay switch.

Accordingly, there remains a need to address the aforementioned technical drawbacks in existing technologies in providing uninterrupted power supply to loads.

### SUMMARY

Embodiments herein provides a method of providing a power supply to a load using a micro-grid and an electrical grid without interrupting a power supply to the load during a power failure and restoration of the electrical grid. The method includes (i) connecting the load to the electrical grid with a smart relay and connecting to the micro-grid, with a smart relay, where the micro-grid has a power supplied by non-grid sources connected to a DC to AC inverter, through a AC to AC synchronization circuit and both the smart relays are controlled by a microcontroller, (ii) detecting a current and a voltage of grid AC power supply and the micro-grid AC power supply by the microcontroller using at least one sensor to determine whether the voltage of the micro-grid or the electric grid is within a predetermined threshold range (iii) monitoring a direction of the current by sensing a difference in the voltage on either side of the smart relay connecting the electrical grid to the micro-grid, (iv) maintaining the current in a direction from the electrical grid to the micro-grid by switching of the smart relay in a way that prevents the current in the direction towards the electrical grid from the micro-grid, or connection of the micro-grid to the load and the electrical-grid when the micro-grid power supply falls below a predetermined threshold, (v) generating inverted DC to AC power at a DC to the AC inverter from the power supply from the non-grid sources at the micro-grid to provide the load and (vi) synchronizing a non-grid AC sine wave to a grid AC sine wave at the AC to AC synchronization circuit when the electrical grid power supply is restored, without turning OFF the DC to the AC inverter by performing synchronization of the non-grid AC sinewave to match the grid AC sine wave over a number of cycles to make the non-grid AC sine wave compatible with the grid power supply while the power supply generated from the non-grid sources remains uninterrupted and the voltage is in the predetermined threshold range for providing to the load, then connecting the non-grid sources to the electrical grid, by controlling the smart relay using the microcontroller and the software control of the smart relay. The smart relay comprises a first relay and a second relay connected to a micro controller and a software that modulates the current and the voltage using a set of transistors.

In some embodiments, the AC to AC synchronization circuit synchronizes the non-grid power supply to the grid-power supply and the predetermined threshold voltage to the load without interrupting power generation at the non-grid sources, before the AC to AC synchronization circuit enables the microcontroller to turn on the smart relay when the grid power supply is restored.

In some embodiments, when the micro-grid power is within the predetermined threshold range and the electric grid power is within threshold range, the micro-grid AC sine wave is slowly synchronized with the electric grid AC sine wave using the AC to AC synchronization circuit and the smart relay that is turned on.

In some embodiments, the first relay is turned off and the second relay is turned on or kept on when the micro-grid power is within a predetermined threshold range and the electric grid power is not within threshold range and current flow is not in the direction from the electric grid to the micro-grid.

In some embodiments, the second relay is turned off when the micro-grid voltage is not within the predetermined threshold range.

In some embodiments, the second relay is turned off when the micro-grid voltage is not within a predetermined threshold range. The first relay is turned off if the electric grid power is not within a predetermined threshold range.

In some embodiments, when the micro-grid voltage is not within a predetermined threshold range the second relay is turned off and if the electric grid power is within a predetermined threshold range the first relay is turned on.

In some embodiments, for generating a positive half of the AC sine wave a first transistor and a fourth transistor are triggered with electrical pulses on a first gate and a fourth gate and for a negative half of the AC sine wave a second transistor and a third transistor are triggered with electrical pulses on a second gate and a third gate, and the AC voltage is then passed through RC filters to provide a sine wave output.

In some embodiments, the microgrid sinewave is synchronized with the grid AC sine wave in a range of 1 to 30 cycles.

In another aspect, an Uninterrupted Power Supply (UPS) system for providing a power supply to a load using a micro-grid and an electrical grid without interrupting a power supply to the load during a power failure and restoration of the electrical grid. The system includes the load, the electric grid, microcontroller, the micro-grid and an AC to AC synchronization circuit. The load is connected to the electrical grid with a smart relay. The microcontroller is connected to the micro-grid that has a power supplied by non-grid sources. The microcontroller detects a current and a voltage of grid AC power supply and the micro-grid AC power supply using at least one sensor to determine if the voltage of the micro-grid or the electric grid is within a predetermined threshold range. The AC to AC synchronization circuit that synchronizes a non-grid AC sine wave to a grid AC sine wave without interrupting power generation at the non-grid sources by performing synchronization of the non-grid AC sinewave to match the grid AC sine wave over a number of cycles to make the non-grid AC sine wave compatible with the grid power supply while the power supply generated from the non-grid sources remains uninterrupted and the voltage in the predetermined threshold for providing to the load, by controlling the smart relay using the microcontroller and the software control of the smart relay.

In some embodiments, the system Uninterrupted Power Supply (UPS) includes at least one of a DC to AC inverter, AC-DC converter, a DC-DC conditioning circuit. The Uninterrupted Power Supply (UPS) system performs at least one of online or offline uninterrupted power supply operations.

The system is a combination of off-line UPS system and grid-tie mechanism, thus, the Uninterrupted Power Supply (UPS) system merges the benefits of the off-line UPS system and grid-tied inverter. In the Uninterrupted Power Supply (UPS) system, the off-line UPS system and the grid-tie mechanism are used in conjunction with the relay to provide a truly uninterrupted power supply to the load without even the momentary glitch caused by the relay. The system switches between the electrical grid and/or the non-grid sources without interruption and ensures that the non-grid sources are utilized to the fullest and only differential power requirement is supplemented by the electrical grid. The Uninterrupted Power Supply (UPS) system enables smart sharing of the electrical grid and the non-grid sources that can be optimized based on availability, abundance and cost of the non-grid sources. The Uninterrupted Power Supply (UPS) system shields the electrical grid from the AC power generated inside the microgrid (i.e. non-grid sources) when the power in the electric grid is restored. The Uninterrupted Power Supply (UPS) system also ensures that no energy flows back from the micro grid to the electrical grid infrastructure. Due to the offline UPS topology, the Uninterrupted Power Supply (UPS) system ensures that there is no energy loss with double conversion, thus, ensuring efficiencies in the beyond 95%.

### BRIEF DESCRIPTION OF THE DRAWINGS

The embodiments herein will be better understood from the following detailed description with reference to the drawings, in which:

FIG. 1 is a block diagram that illustrates an uninterruptible power supply (UPS) system for providing uninterrupted power supply to a load using one or more energy sources according to some embodiments herein;

FIG. 2 is an exemplary diagram of an UPS system of FIG. 1 for providing uninterrupted power supply to a critical load (Lc) according to some embodiments herein;

FIG. 3 is an exemplary diagram of an UPS system of FIG. 1 for providing uninterrupted power supply to a load without battery according to some embodiments herein;

FIG. 4 is an exemplary diagram of a switching circuit to convert DC power to AC power inside theUPS system of FIG. 1 for providing uninterrupted power supply to a load according to some embodiments herein;

FIG. 5A is an exemplary signal diagram of controlled switching of DC power signal to create a sinusoidal AC signal inside the UPS system of FIG. 1 for providing uninterrupted power supply to the load according to some embodiments herein;

FIG. 5B is an exemplary signal diagram of the UPS system of FIG. 1 for synchronizing AC power from the microgrid to the grid according to some embodiments herein; and

FIG. 6 is a flow diagram that illustrate a method for providing an uninterrupted power supply to a load using the UPS system of FIG. 1 according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

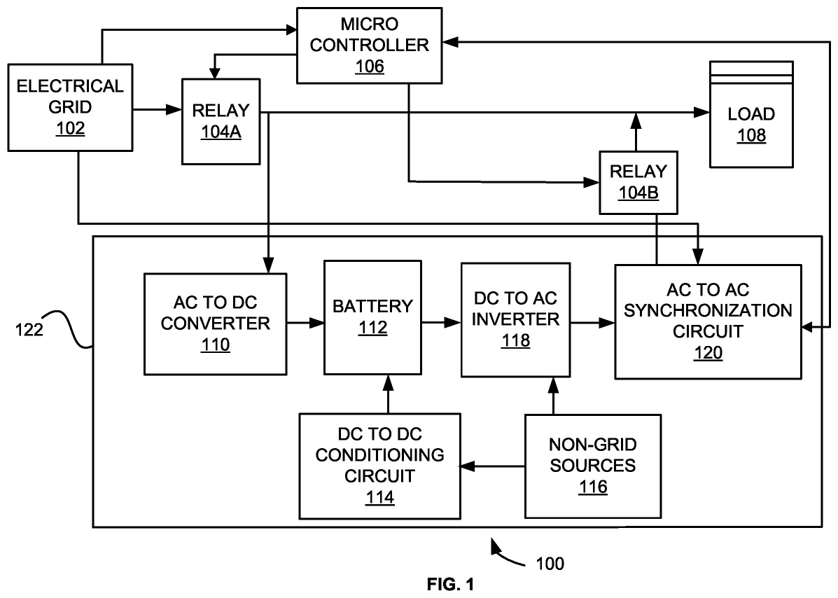

As mentioned, there remains a need for a system and method for providing an uninterrupted power supply by transitioning between various energy sources with a possibility of utilizing non-grid sources to the fullest and drawing only differential power requirement from a grid source. Referring now to the drawings, and more particularly to FIGS. 1 through 6, where similar reference characters denote corresponding features consistently throughout the figures, there are shown preferred embodiments.

FIG. 1 is a block diagram that illustrates an Uninterruptible Power Supply (UPS) system 100 for providing a power supply to a load 108 without interrupting the power supply to the load 108 during a power failure and restoration of an electrical grid 102 when the power resumes according to some embodiments herein. The UPS system 100 includes the electrical grid 102, smart relays, a microcontroller 106, the load 108 and a micro grid 122. The smart relays includes a first relay 104A and a second relay 104B. The micro grid 122 includes an AC to DC converter 110, a battery 112, a DC to DC conditioning circuit 114, non-grid sources 116, a DC to AC inverter 118 and an AC to AC synchronization circuit 120. The non-grid sources 116 may include at least one of solar, wind, tidal, hydro, fuel cell or biomass energy. The load 108 may include any of electrical loads. The load 108 is connected to the electrical grid 102 with the first relay 104A. The microcontroller 106 is connecting to the micro-grid 122 that has a power supplied by non-grid sources 116. The microcontroller 106 detects a current and a voltage of grid AC power supply and a micro-grid AC power supply using at least one sensor to determine if the voltage of the micro-grid 122 or the electric grid 102 is within a predetermined threshold range.

The AC to AC synchronization circuit 120 synchronizes a non-grid AC sine wave to a grid AC sine wave without interrupting power generation from the non-grid sources 116 by performing synchronization of the non-grid AC sinewave to match the grid AC sine wave over a number of cycles to make the non-grid AC sine wave compatible with the grid power supply while the power supply generated from the non-grid sources 116 remains uninterrupted and the voltage is in the predetermined threshold range for providing to the load 108 by controlling the first relay 104A and the second relay 104B using the microcontroller 106 and a software control of the first relay 104A and the second relay 104B.

In some embodiments, the electrical grid 102 is connected with the battery 112 and the load 108 in the microgrid 122 using a first relay 104A. The electrical grid 102 supplies Alternate Current (AC) power to the load 108 to run the load 108 directly. The AC power from the electrical grid 102 is converted into Direct Current (DC) power using the AC to DC converter 110 to charge the battery 112 in the micro grid 122. The non-grid sources 116 in the microgrid 122 are connected with the battery 112 and the load 108 using the DC to DC conditioning circuit 114. The non-grid sources 116 supplies DC power to the DC to DC conditioning circuit 114 which boosts DC power voltage of the non-grid sources to match with a DC bus voltage to charge the battery 112.

In some embodiments, the battery 112 is charged with the electrical grid 102 and the non-grid sources 116. The non-grid sources 116 supplies the DC power to the load 108 through the DC to AC inverter 118 and the AC to AC synchronization circuit 120. The DC to AC inverter 118 inverts the DC power from the battery 112 into AC power. The AC to AC synchronization circuit 120 synchronizes the AC power from the DC to AC inverter 118 with the AC power from the electrical grid 102 to supply to the load 108. In some embodiments, the non-grid sources 116 directly supplies the DC power to the load 108 through the DC to AC inverter 118 and the AC to AC synchronization circuit 120. The AC to AC synchronization circuit 120 may include a Phase Locked Loop (PLL) circuit which may receive a phase and a frequency of the AC power of the electrical grid 102 as a reference AC power. The PLL circuit may detect the phase and the frequency of the AC power from the DC to AC inverter 118 using a phase detector. The PLL circuit may adjust the phase and the frequency of the AC power from the DC to AC inverter 118 to the reference power to synchronize the AC power of the DC to AC inverter 118 with the AC power of the electrical grid 102 using a power switching circuit, which in turn stabilizes the AC power to the load 108. The reference AC power may be provided to a first port of the phase detector and the AC power of the DC to AC inverter 118 is passed to a second port of the phase detector for synchronization. In some embodiments, the AC power of the non-grid sources 116 and/or the battery 112 is passed to the load 108 after synchronization with the AC power from the electrical grid 102 using the AC to AC synchronization circuit 120.

The first relay 104A connected between the electrical grid 102 and the load 108 switches the UPS system 100 to operate in a grid-connected mode and a grid-disconnected mode for providing the uninterrupted power supply to the load 108. In the grid-connected mode, the UPS system 100 supplies the AC power to the load 108 from the electrical grid 102 and from the micro-grid 122 powered by non-grid sources. In the grid-disconnected mode, the UPS system 100 supplies the AC power to the load 108 from the at least one of non-grid sources 116 and/or battery 112 in the micro grid 122. In some embodiments, the grid-disconnected mode is enabled during power failure of the electrical grid 102. In some embodiments, the grid-disconnected mode is enabled during a reverse flow of the AC power into the electrical grid 102 from the micro grid 122. The first relay 104A may be a switch to close and open the circuits electronically and electromechanically. The first relay 104A and the second relay 104B may include at least one of an electromagnetic relay, a solid state relay, a hybrid relay, a thermal relay or a reed relay.

In some embodiments, a switching function of the first relay 104A from the grid-connected mode to the grid-disconnected mode is controlled by the microcontroller 106 which is operably communicated with the electrical grid 102, the first relay 104A and the microgrid 122. The microcontroller 106 detects current and voltage of the electrical grid AC power continuously and controls the switching function of the first relay 104A based on the detected current and voltage of the electrical grid AC power. The microcontroller 106 may use one or more sensors to detect the current and voltage of the electrical grid AC power. The microcontroller 106 may switch the UPS system 100 to the grid-connected mode by closing the first relay 104A if the current and the voltage of the electrical grid AC power is within the predetermined threshold range and the AC power from the micro-grid is synchronized with AC power from electrical grid or if the micro-grid is disconnected from the load. The microcontroller 106 may switch the UPS system 100 to the grid-disconnected mode by opening the first relay 104A if the current and the voltage of the electrical grid AC power exceeds the predetermined threshold range. The predetermined threshold range may include allowable limit values of the current and the voltage of the electrical grid AC power. The one or more sensors may include at least one of a current sensor, a voltage sensor, a power meter or any suitable sensors. The microcontroller 106 may include at least one of a microcontroller or PIC microcontroller.

In some embodiments, if the microcontroller 106 detects the current and the voltage of the electrical grid AC power that is in the predetermined threshold range (or during positive power flow from the electrical grid 102 to the Load) and the AC power from the microgrid is in synchronization with AC power from the grid, the microcontroller 106 closes the second relay 104B to operate the UPS system 100 in the grid-connected mode. In the grid-connected mode, the first relay 104A enables the passing of the AC power from the electrical grid 102 to the load 108.

In some embodiments, if the microcontroller 106 detects the current and the voltage of the electrical grid AC power exceeds the predetermined threshold range (or during power failure of the electrical grid 102), the microcontroller 106 opens the first relay 104A to operate the UPS system 100 in the grid-disconnected mode. In the grid-disconnected mode, the first relay 104A (i) disconnects the electrical grid 102 from the microgrid 122 and the load 108, (ii) allows the non-grid sources 116 and/or the battery 112 in the microgrid 122 to supply the AC power to the load 108, and (iii) protects the electrical grid 102 from the flow of AC power from the non-grid sources 116 to the microgrid 122.

If the microcontroller 106 detects the current and the voltage of the electrical grid AC power that is in the predetermined threshold range after the power failure of the electrical grid 102 (or when the electrical grid 102 is restored the AC power), the microcontroller 106 controls the AC to AC synchronization circuit 120 to synchronize the AC power from the non-grid sources 116 and/or the battery 112 with the AC power of the electrical grid 102 before closing the first relay 104A to operate the UPS system 100 back to the grid-connected mode. The microcontroller 106 may connect with the PLL circuit of the AC to AC synchronization circuit 120 in the microgrid 122 and activate the PLL circuit to receive the phase and the frequency information of the AC power from the electrical grid 102 when the AC power is restored in the electrical grid 102. The PLL circuit may receive the phase and the frequency of the AC power from the electrical grid 102 and match the phase and the frequency of the AC power from the microgrid 116 and/or the battery 112 passing through the DC to AC inverter 118 to the AC power from the grid sources 102 to synchronize the AC power of the non-grid sources 116 and/or the battery 112 to that of the electrical grid 102.

The PLL circuit may send a synchronizing signal to the microcontroller 106 after matching the phase and the frequency of the AC power from the electrical grid 102 to the AC power from the non-grid sources 116 and/or the battery 112. The microcontroller 106 may close the first relay 104A upon receiving the synchronizing signal from the PLL circuit of the AC-AC synchronization circuit 120 to enable the UPS system 100 to operate in the grid-connected mode. This ensures the uninterrupted power supply to the load 108 without even a momentary break and with the utilization of the power from the non-grid sources 116 to the maximum extent.

In some embodiments, the AC to AC synchronization circuit synchronizes the non-grid power supply to the grid-power supply and the predetermined threshold voltage to the load without interrupting power generation at the non-grid sources, before the AC to AC synchronization circuit enables the microcontroller to turn on the smart relay when the grid power supply is restored.

In some embodiments, the microgrid sinewave is synchronized with the grid AC sine wave in a range of 1 to 30 cycles.

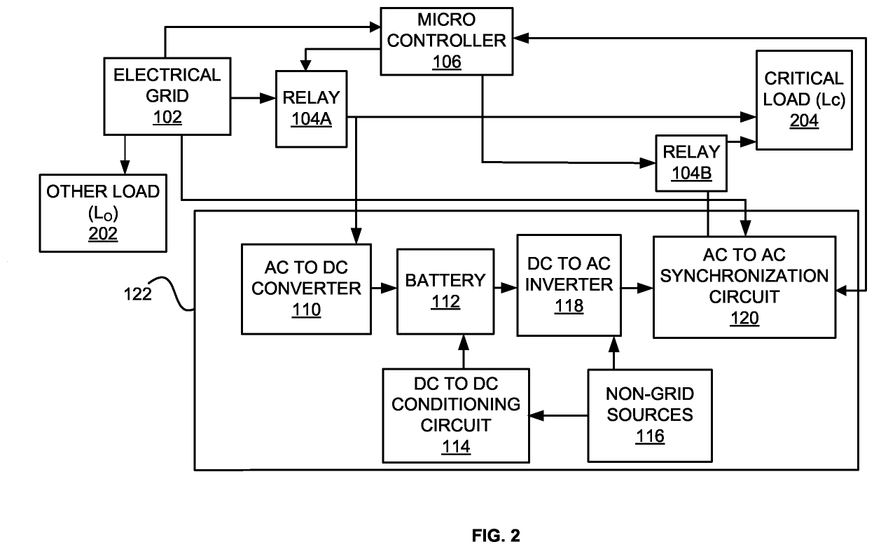

FIG. 2 is an exemplary diagram of an UPS system of FIG. 1 for providing uninterrupted power supply to a critical load (Lc) according to some embodiments herein. The UPS system 100 supplies power to the critical load (Lc) 204. The electrical grid 102 is connected with the other load (Lo) 202 and supplies Alternate Current (AC) power to the other load (Lo) 202 to run the other load (Lo) 202 directly. The electrical grid 102 is connected with the microgrid 122 to supply the AC power (i) to charge the battery 112 and (ii) to run the critical load 204. The AC power from the electrical grid 102 is converted into Direct Current (DC) power using the AC to DC converter 110 to charge the battery 112 in the micro grid 122. The non-grid sources 116 are connected with the battery 112 and the critical load (Lc) 204 using the DC to DC conditioning circuit 114. The DC to AC inverter 118 inverts the DC power from the battery 112 into AC power and the AC to AC synchronization circuit 120 synchronizes the AC power from the DC to AC inverter 118 with AC power from the electrical grid 102 to supply to the critical load (Lc) 204. The first relay 104A and the second relay 104B are connected between the electrical grid 102 or the micro grid 122 and the critical load (Lc) 204 to control the supply of the AC power from the electrical grid 102 and the non-grid sources 116 and/or battery 112 in the microgrid 122 to the critical load 204. In some embodiments, the first relay 104A and the second relay 104B are a dual switch relay.

The first relay 104A and the second relay 104B are switching the UPS system 100 to operate in at least one of the grid-connected mode or the grid-disconnected mode for providing uninterrupted power supply to the critical load (Lc) 204. The switching function of the first relay 104A that is switching from the grid-connected mode to the grid-disconnected mode is controlled by the microcontroller 106 which is operably communicated with the electrical grid 102, the second relay 104B and the microgrid 122. The microcontroller 106 continuously detects the current and the voltage of the electrical grid AC power using the one or more sensors and controls the switching function of the second relay 104B based on sensor data received from the one or more sensors.

If the microcontroller 106 detects the current and the voltage of the electrical grid AC power that is in the predetermined threshold range (or during the positive power flow from the electrical grid 102 to the load) the AC power from the microgrid is in synchronization with AC power from the grid, the microcontroller 106 closes the first relay 104A to operate the UPS system 100 in the grid-connected mode. In the grid-connected mode, the first relay 104A enables the passing of the AC power from the electrical grid 102 to the critical load (Lc) 204.

If the microcontroller 106 detects the current and the voltage of the electrical grid power that is not within the predetermined threshold range, the microcontroller 106 controls the first relay 104A by sending a control signal to shut the supply of the AC power from AC grid sources. The AC to AC synchronization circuit 120 may include a breaker which shuts the supply of the AC power from the AC grid sources when the first relay 104A receives the control signal from the microcontroller 106. The AC to AC synchronization circuit 120 sends a PLL shut down signal to the microcontroller 106 once the breaker shuts down the supply of the AC power to the critical load (Lc) 204. The microcontroller 106 enables the first relay 104A to operate the UPS system 100 in the grid-disconnected mode upon receiving the PLL shut down signal from the AC to AC synchronization circuit 120. In the grid-disconnected mode, the second relay 104B enables the supply of the AC power from the non-grid sources 116 and/or battery 112 through the DC to AC inverter 118 to the critical load (Lc) 204. The breaker may be a relay or any suitable switch. The other load (Lo) 202 that is directly connected with the electrical grid 102 losses the supply of the AC power from the electrical grid 102, when there is power failure in the electrical grid 102.

If the microcontroller 106 detects the current and the voltage of the electrical grid power that is in the predetermined threshold range after the power failure of the electrical grid 102 (or when the electrical grid 102 is restored the power), the microcontroller 106 enables the AC to AC synchronization circuit 120 to synchronize the AC power from the non-grid sources 116 and/or the battery 112 with the AC power of the electrical grid 102 before closes the first relay 104A to operate the UPS system 100 back to the grid-connected mode. The microcontroller 106 may connect with the PLL circuit of the AC to AC synchronization circuit 120 in the microgrid 122 and activate the PLL circuit to receive the phase and the frequency of the AC power from the electrical grid 102 when the AC power is restored in the electrical grid 102. The PLL circuit may receive the phase and the frequency information of the AC power from the electrical grid 102 and match the phase and the frequency of the AC power from the electrical grid 102 to the AC power from the non-grid sources 116 and/or the battery 112 passing through the DC to AC inverter 118 to synchronize the AC power of the electrical grid 102 with the AC power of the non-grid sources 116 and/or the battery 112. The PLL circuit may send the synchronizing signal to the microcontroller 106 after matching the phase and the frequency of the AC power from the electrical grid 102 to the AC power from the non-grid sources 116 and/or the battery 112. The microcontroller 106 may close the first relay 104A upon receiving the synchronizing signal from the PLL circuit of the AC-AC synchronization circuit 120 to enable the UPS system 100 to operate in the grid-connected mode. This ensures the uninterrupted power supply to the load 108 without even a momentary glitch caused by the smart relays (104A and 104B) and with the utilization of the non-grid sources 116 to the maximum extent. In some embodiments, the first relay 104A may automatically block the supply of the AC power from the electrical grid 102 until the AC power of microgrid 122 synchronised with the AC power of the electrical grid 102. The other load (Lo) 202 is supplied with the electrical grid AC power when the power restores in the electrical grid 102.

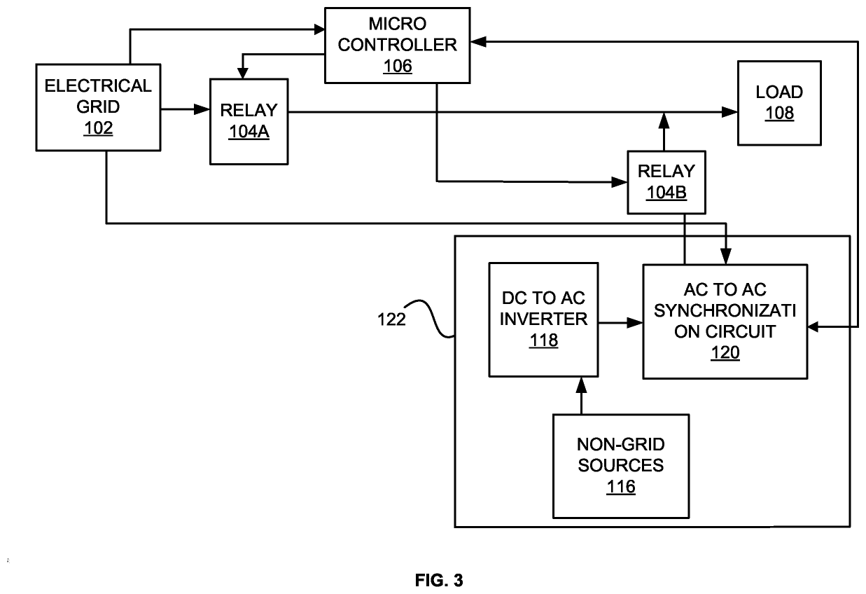

FIG. 3 is an exemplary diagram of an UPS system of FIG. 1 for providing uninterrupted power supply to a load without battery according to some embodiments herein.

The UPS system 100 supplies power to the load 108 from the electrical grid 102 and the non-grid sources 116 directly without battery and circuits related to AC to DC conversion. The electrical grid 102 supplies Alternate Current (AC) power to the load 108 to run the load 108 directly. The non-grid sources 116 in the microgrid 122 supplies Direct Current (DC) power to the load 108 through the DC to AC inverter 118 and the AC to AC synchronization circuit 120. The DC to AC inverter 118 inverts the DC power from the non-grid sources 116 into AC power and the AC to AC synchronization circuit 120 synchronizes the AC power from the DC to AC inverter 118 with AC power from the electrical grid 102 to supply to the load 108.

The first relay 104A that is connected between the electrical grid 102 and the micro grid 122 switches the UPS system 100 to operate in grid-connected mode and grid-disconnected mode for providing uninterrupted power supply to the load 108. The switching function of the first relay 104A from the grid-connected mode to the grid-disconnected mode is controlled by the microcontroller 106 which is operably communicated with the electrical grid 102, the first relay 104A and the microgrid 122. The microcontroller 106 detects current and voltage of the electrical grid AC power continuously using the one or more sensors and controls the switching function of the first relay 104A based on sensor data.

If the microcontroller 106 detects the current and the voltage of the electrical grid AC power that is in the predetermined threshold range (or during positive power flow from the electrical grid 102 to the Load), the microcontroller 106 enables the AC to AC synchronization circuit 120 to synchronize the AC power from the non-grid sources 116 and/or the battery 112 with the AC power of the electrical grid 102 before closing the first relay 104A to operate the UPS system 100 back to the grid-connected mode. The microcontroller 106 closes the first relay 104A to operate the UPS system 100 in the grid-connected mode, which enables the passing of the AC power from the electrical grid 102 and the non-grid sources 116 in the microgrid 122 to the load 108.

If the microcontroller 106 detects the current and the voltage of the electrical grid power that is not within the predetermined threshold range or during power failure of the electrical grid 102, the microcontroller 106 opens the first relay 104A to operate the UPS system 100 in the grid-disconnected mode, which (i) disconnects the electrical grid 102 from the microgrid 122 and the load 108 (ii) allows the non-grid sources 116 in the microgrid 122 to supply the AC power to the load 108; and (iii) protects the electrical grid 102 from the AC power of the non-grid sources 116 in the microgrid 122.

If the microcontroller 106 detects the current and the voltage of the electrical grid power that is in the predetermined threshold range after the power failure of the electrical grid 102 (or when the electrical grid 102 has restored the power), the microcontroller 106 controls the AC to AC synchronization circuit 120 to synchronize the AC power from the non-grid sources 116 with the AC power of the electrical grid 102 before closeing the first relay 104A to operate the UPS system 100 back to the grid-connected mode.

In some embodiments, when the micro-grid power is within the predetermined threshold range and the electric grid power is within threshold range, the micro-grid AC sine wave is slowly synchronized with the electric grid AC sine wave using the AC to AC synchronization circuit before the smart relay is turned on.

In some embodiments, the first relay 104A is turned off and the second relay 104B is turned on or kept on when the micro-grid power is within a predetermined threshold range and the electric grid power is not within threshold range and current flow not in the direction from the electric grid 102 to the micro-grid 122.

In some embodiments, the second relay 104B is turned off when the micro-grid voltage is not within a predetermined threshold.

In some embodiments, the second relay 104B is turned off when the micro-grid voltage is not within a predetermined threshold. The first relay 104A is turned off if the electric grid power is not within a predetermined threshold.

In some embodiments, when the micro-grid voltage is not within a predetermined threshold range the second relay 104B is turned off and if the electric grid power is within a predetermined threshold range the first relay 104A is turned on.

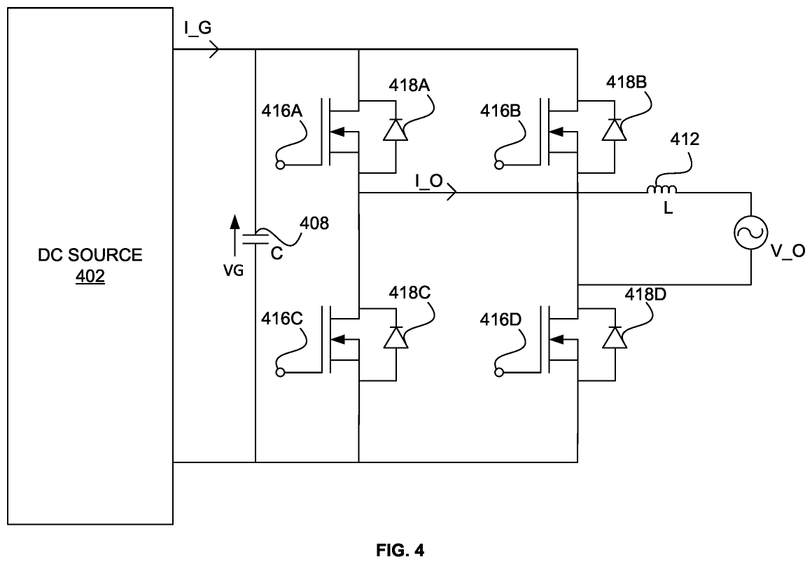

FIG. 4 is an exemplary diagram of a switching circuit to convert DC power to AC power inside theUPS system of FIG. 1 for providing uninterrupted power supply to a load according to some embodiments herein. The DC to AC inverter 118 includes a DC source 402, a capacitor 408, an inductor 412, one or more gates 416A-D and one or more transistors 418A-D. The DC to AC inverter 118 generates a positive half of the AC sine wave using a first transistor 418A and a fourth transistor 418D. The first transistor 418A and the fourth transistor 418D are triggered with electrical pulses on a first gate 416A and a fourth gate 416D. The DC to AC inverter 118 generates a negative half of the AC sine wave using a second transistor 418 B and a third transistor 418C are triggered with electrical pulses on a second gate 416B and a third gate 416C. The AC voltage is then passed through RLC filters to provide a sine wave output. In some embodiments, the RLC filters includes the resistor, the inductor 412 and the capacitor 408. The sine wave output is a non-grid sine wave which is then synchronized by an AC to AC synchronization circuit 120 to a grid AC sine wave without interrupting power generation at the non-grid sources by performing synchronization of the non-grid AC sinewave to match the grid AC sine wave over a number of cycles to make the non-grid AC sine wave compatible with the grid power supply. Also, the power supply generated from the non-grid sources 116 remains uninterrupted and the voltage in the predetermined threshold for providing to the load 108. The smart relay using the microcontroller 106 and the software control of the smart relay ensure unidirectional flow of current, enabling synchronizing of the non-grid sine wave to match the grid sine wave over a few cycles. The non-grid sine wave to become compatible to the grid sine wave may take about 30-90 seconds time, without any interruption caused in the power supply.

With reference to FIG. 4, 5A is an exemplary signal diagram of controlled switching of DC power signal to create a sinusoidal AC signal inside the UPS system of FIG. 1 for providing uninterrupted power supply to the load according to some embodiments herein. The voltage is represented by the X-axis and the current is represented by the Y-axis. The DC voltage output is represented by graph as shown. The positive and negative part of the voltage output is equal and symmetrical, switching on and off this signal generating a sine wave. The DC to AC inverter 118 converts an input square wave 502 into a sine wave 504. In some embodiments, the sine wave 504 is an AC power. In some embodiments, the for generating a positive half of the AC sine wave a first transistor and a fourth transistor are triggered with electrical pulses on a first gate and a fourth gate and for negative half of the AC sine wave a second transistor and a third transistor are triggered with electrical pulses on a second gate and a third gate, and the AC voltage is then passed through RC filters to provide a sine wave output.

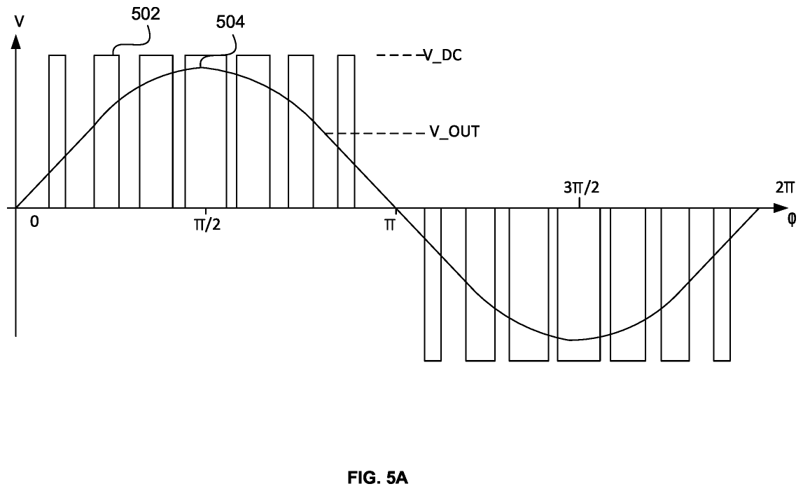

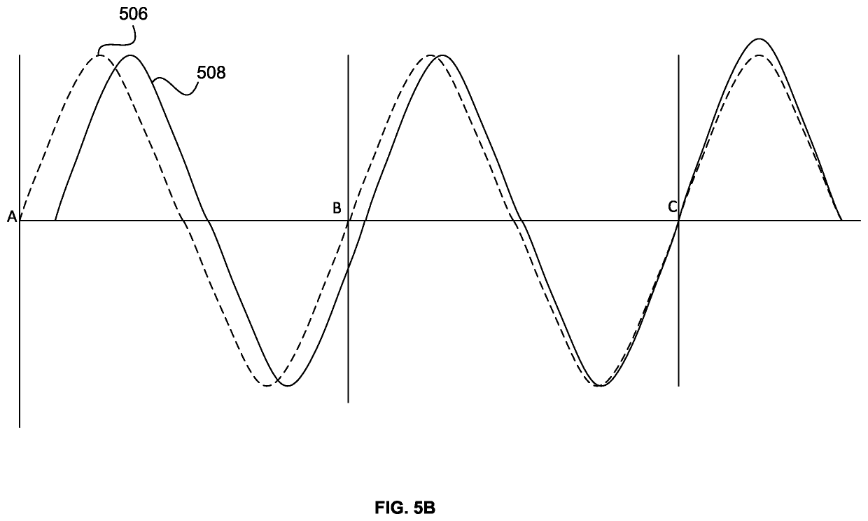

With reference to FIG. 1, FIG. 5B is an exemplary signal diagram of the UPS system of FIG. 1 for synchronizing AC power from the microgrid to the grid according to some embodiments herein. The AC to AC synchronization circuit 120 synchronizes the non-grid sine wave 508 with a grid sine wave 506 over a number of cycles. The non-grid AC sine wave 508 is compared with the grid AC sine wave 506 over the number of cycles at points A, B, C as shown. The phase difference between the non-grid AC sine wave 508 is slowly diminished going from A to C with the grid AC sine wave 506 by performing synchronization of the non-grid AC sinewave 508 to match the grid AC sine wave 506 over a number of cycles (in an example here, three as shown) to make the non-grid AC sine wave compatible with the grid power supply. The AC to AC synchronization circuit 120 synchronizes the grid AC power 506 with the non-grid AC power 508 without turning off the microgrid power. In some embodiments, the AC to AC synchronization circuit 120 synchronizes the non-grid AC power 508 with the grid AC power 506 before switching the UPS system 100 into grid-connected mode.

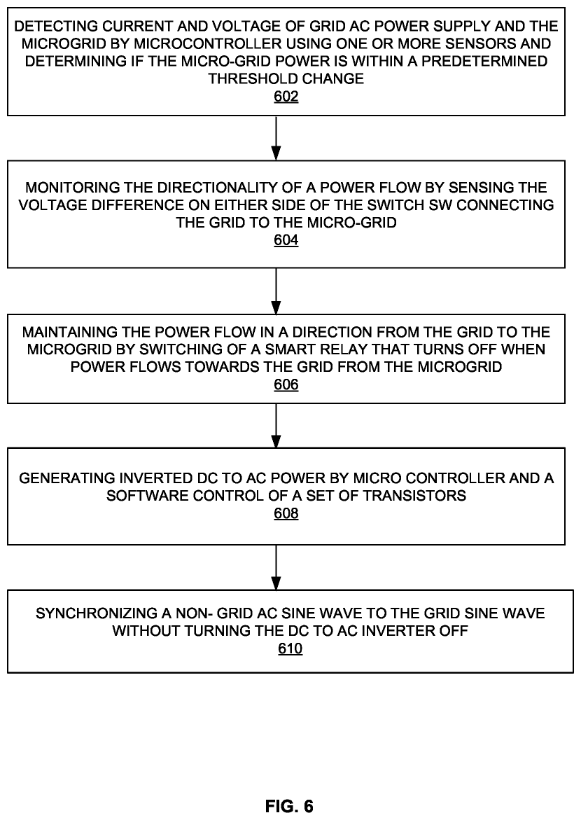

FIG. 6 is a flow diagram that illustrate a method for providing an uninterrupted power supply to a load using an UPS system 100 of FIG. 1 according to some embodiments herein. The load 108 is connected to the electrical grid 102 with the first relay 104A and connecting to the micro-grid 122, with the second relay 104B, where the micro-grid has a power supplied by non-grid sources 116 connected to a DC to AC inverter 118, through a AC to AC synchronization circuit 120 and both the smart relays 104A and 104B are controlled by a microcontroller 106. At step 602, a current and a voltage of grid AC power supply and the micro-grid AC power supply is detected by the microcontroller 106 using at least one sensor to determine whether the voltage of the micro-grid 122 or the electric grid 102 is within the predetermined threshold range. At step 604, a direction of the current is monitored by sensing a difference in the voltage on either side of the first relay 104A connecting the electrical grid 102 to the micro-grid 122. At step 606, the current is maintained in a direction from the electrical grid 102 to the micro-grid 122 by switching of the smart relay 104A and 104B in a way that prevent the current in the direction towards the electrical grid 102 from the micro-grid 122, or connection of the micro-grid 122 to the load 108 and the electrical-grid 102 when the micro-grid power supply falls below the predetermined threshold. The smart relay 104A and 104B comprises the first relay 104A and the second relay 104B connected to a micro controller 106 and a software that modulates the current and the voltage using a set of transistors. At step 608, inverted DC to AC power is generated at a DC to the AC inverter 118 from the power supply from the non-grid sources 116 at the micro-grid 122 to provide the load 108. At step 610, a non-grid AC sine wave is synchronized to a grid AC sine wave at the AC to AC synchronization circuit 120 when the electrical grid 102 power supply is restored, without turning OFF the DC to the AC inverter 118 by performing synchronization of the non-grid AC sinewave to match the grid AC sine wave over a number of cycles to make the non-grid AC sine wave compatible with the grid power supply while the power supply generated from the non-grid sources 116 remains uninterrupted and the voltage is in the predetermined threshold range for providing to the load 108, then connecting the non-grid sources 116 to the electrical grid 102, by controlling the smart relay 104A using the microcontroller 106 and the software control of the smart relay 104A.

The system enables smart sharing of the electrical grid and the non-grid sources that can be optimized on power availability and cost of the non-grid sources. The system shields the electrical grid from the AC power generated inside the microgrid (i.e. non-grid sources) when the power in the electric grid is restored. The system also ensures that no energy flows back from the micro grid to the electrical grid infrastructure. Due to the offline UPS topology, the system ensures that there is no energy loss with double conversion, thus, ensuring efficiencies in the beyond 95%.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

I/We claim:

1. A method of providing a power supply to a load (108) using a micro-grid (122) and an electrical grid (102) without interrupting a power supply to the load (108) during a power failure and restoration of the electrical grid (102), the method comprising:
connecting the load (108) to the electrical grid (102) with a smart relay (104A) and connecting to the micro-grid (122), with a smart relay (104B), where the micro-grid has a power supplied by non-grid sources (116) connected to a DC to AC inverter (118), through a AC to AC synchronization circuit (120) and both the smart relays (104A and 104B) are controlled by a microcontroller (106);
detecting a current and a voltage of grid AC power supply and the micro-grid AC power supply by the microcontroller (106) using at least one sensor to determine whether the voltage of the micro-grid (122) or the electric grid (102) is within a predetermined threshold range; Characterized in that
monitoring a direction of the current by sensing a difference in the voltage on either side of the smart relay (104A) connecting the electrical grid (102) to the micro-grid (122);
maintaining the current in a direction from the electrical grid (102) to the micro-grid (122) by switching of the smart relay (104A and 104B) in a way that prevent the current flow in the direction towards the electrical grid (102) from the micro-grid (122), or connection of the micro-grid (122) to the load (108) and the electrical-grid (102) when the micro-grid power supply falls below a predetermined threshold range, wherein the smart relay (104A and 104B) comprises a first relay (104A) and a second relay (104B) connected to a micro controller (106) and a software that modulates the current and the voltage using a set of transistors;
generating inverted DC to AC power at a DC to the AC inverter (118) from the power supply from the non-grid sources (116) at the micro-grid (122) to provide the load (108); and
synchronizing a non-grid AC sine wave to a grid AC sine wave at the AC to AC synchronization circuit (120) when the electrical grid (102) power supply is restored, without turning OFF the DC to the AC inverter (118) by performing synchronization of the non-grid AC sinewave to match the grid AC sine wave over a number of cycles to make the non-grid AC sine wave compatible with the grid power supply while the power supply generated from the non-grid sources (116) remains uninterrupted and the voltage is in the predetermined threshold range for providing to the load (108), then connecting the non-grid sources (116) to the electrical grid (102), by controlling the smart relay (104A) using the microcontroller (106) and the software control of the smart relay (104A).

2. The method as claimed in claim 1, wherein the AC to AC synchronization circuit (120) synchronizes the non-grid power supply to the grid-power supply and a predetermined threshold voltage to the load (108) without interrupting power generation at the non-grid sources, before the AC to AC synchronization circuit (120) enables the microcontroller to turn on the smart relay (104A) when the grid power supply is restored.

3. The method as claimed in claim 1, wherein when the micro-grid (122) power is within the predetermined threshold range and the electric grid (102) power is within the predetermined threshold range, the micro-grid AC sine wave is slowly synchronized with the electric grid AC sine wave using the AC to AC synchronization circuit (120) and the smart relay (104A) that is turned on.

3. The method as claimed in claim 1, wherein the first relay (104A) is turned off and the second relay (104B) is turned on or kept on when the micro-grid (122) power is within the predetermined threshold range and the electric grid (102) power is not within the predetermined threshold range and current flow is not in the direction from the electric grid (102) to the micro-grid (122).

4. The method as claimed in claim 1, wherein the second relay (104B) is turned off when the micro-grid (122) voltage is not within the predetermined threshold range. cm 5. The method as claimed in claim 1, wherein the first relay (104A) is turned off if the electric grid (102) power is not within a predetermined threshold range.

6. The method as claimed in claim 1, wherein when the micro-grid (122) voltage is not within the predetermined threshold range the second relay (104B) is turned off and if the electric grid (102) power is within the predetermined threshold range the first relay (104A) is turned on.

7. The method as claimed in claim 1, wherein for generating a positive half of the AC sine wave a first transistor (418A) and a fourth transistor (418D) are triggered with electrical pulses on a first gate (416A) and a fourth gate (416D) and for a negative half of the AC sine wave a second transistor (418B) and a third transistor (418C) are triggered with electrical pulses on a second gate (416B) and a third gate (416C), and the AC voltage is then passed through RLC filters to provide a sine wave output.

8. The microgrid sinewave is synchronized with the grid AC sine wave in a range of 1 to 30 cycles

9. An Uninterrupted Power Supply (UPS) system (100) for providing a power supply to a load (108) using a micro-grid (122) and an electrical grid (102) without interrupting a power supply to the load (108) during a power failure and restoration of the electrical grid (102), the UPS system (100) comprising:
the load (108);
the electric grid (102), wherein the load is connected to the electrical grid (102) with a smart relay (104A);
a microcontroller (106) connecting to the micro-grid (122) that has a power supplied by non-grid sources (116) or grid sources (102) or an independent source or a battery, wherein the microcontroller (106) detects a current and a voltage of grid AC power supply and the micro-grid AC power supply using at least one sensor to determine if the voltage of the micro-grid (122) or the electric grid (102) is within a predetermined threshold range;
an AC to AC synchronization circuit (120) that synchronizes a non-grid AC sine wave to a grid AC sine wave without interrupting power generation at the non-grid sources by performing synchronization of the non-grid AC sinewave to match the grid AC sine wave over a number of cycles to make the non-grid AC sine wave compatible with the grid power supply while the power supply generated from the non-grid sources (116) remains uninterrupted and the voltage in the predetermined threshold for providing to the load (108), by controlling the smart relay using the microcontroller (106) and the software control of the smart relay (104A,104B).

10. The Uninterrupted Power Supply (UPS) system (100) as claimed in claim 4, wherein the UPS system (100) comprises at least one of a DC to AC inverter (118), AC-DC converter (110), a DC-DC conditioning circuit 114, wherein the Uninterrupted Power Supply (UPS) system (100) performs at least one of online or offline uninterrupted power supply operations.
